(19) United States
(12) Patent Application Publication
(10) Pub. No.: US 2007/0238514 A1
(43) Pub. Date: Oct. 11, 2007

(54) Gaming machine

(75) Inventor: Kazunobu Sato, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Aruze Corp., Tokyo (JP)

(21) Appl. No.: 11/727,923

(22) Filed: Mar. 29, 2007

(30) Foreign Application Priority Data
Apr. 6, 2006 (JP) P2006-105495

(51) Int. Cl. A63F 13/00

(52) U.S. Cl. 463/20

(57) ABSTRACT

A gaming machine includes a display and a processor. The display has a plurality of variable display portions. The processor determines the symbol to be displayed in a stopped state on each of the variable display portions of the display, and sets a plurality of activated lines, each of which is constituted by some of the variable display portions aligned in a straight line among the plurality of the variable display portions. The processor also sets at least one of the variable display portions among the plurality of the variable display portions as a specific variable display portion relatively advantageous for a player than each of the variable display portions. The processor changes the number of the specific variable display portions when a specific condition relating to at least one of the variable display portions among the plurality of the variable display portions is met.

### CROSS REFERENCE TO RELATED APPLICATIONS

This application is based upon and claims the benefit of priority from the prior Japanese Patent Application No. 2006-105495, filed on Apr. 6, 2006; the entire contents of which are incorporated herein by reference.

### BACKGROUND OF THE INVENTION

1. Field of the Invention

The present invention relates to a gaming machine, such as a slot machine, including a plurality of variable display portions that variably display a plurality of symbols.

2. Related Background of the Invention

Conventionally, there has been a gaming machine, such as a slot machine, in which a plurality of symbols are variably displayed in a plurality of lines on an image display means and based on a combination of symbols in each line when the variable display (also referred to as scroll display) comes to a stop, whether winning or losing in a game and a combination when a game is won (winning combination) are fixed. With a gaming machine of this type, when symbols displayed fixedly when the variable display in each of the variable display portions comes to a stop are specific symbols, or when the combination of symbols (hereinafter, a combination of symbols is referred to as a “symbol pattern”) is a specific combination, a player shall win the game.

For example, in Japanese Patent Application Laid-Open No. 2006-34722, a slot machine including nine variable display portions in total arranged in three vertical and horizontal lines, respectively, is disclosed.

In the case of the slot machine disclosed in Japanese Patent Application Laid-Open No. 2006-34722, the nine variable display portions in total arranged in three vertical and horizontal lines, respectively, are provided, and therefore, activated lines are set in eight linear patterns in total by the arrangements in three vertical and horizontal lines and arrangements in diagonal lines.

### SUMMARY OF THE INVENTION

An object of the present invention is to provide a diversity to the contents of a game and make the game more attractive in a gaming machine, such as a slot machine, including a plurality of variable display portions that variably display a plurality of symbols and capable of executing games using a plurality of activated lines in a linear pattern, such as a vertical, horizontal, or diagonal linear pattern.

The present invention provides a gaming machine comprising: an image display means having a plurality of variable display portions, each of which variably displays a plurality of symbols; a symbol determination means for determining the symbol to be displayed in a stopped state on each of the variable display portions of the image display means; a line setting means for setting a plurality of activated lines, each of which is constituted by some of the variable display portions aligned in a straight line among the plurality of the variable display portions; a setting means for setting at least one of the variable display portions among the plurality of the variable display portions as a specific variable display portion relatively advantageous for a player than each of the variable display portions; and a variation control means for changing the number of the specific variable display portions when a specific condition relating to at least one of the variable display portions among the plurality of the variable display portions is met.

### BRIEF DESCRIPTION OF THE DRAWINGS

FIG. 1 is a perspective view showing the general configuration of a slot machine, which is a gaming machine according to an embodiment of the present invention.

FIG. 2 is a block diagram of a slot machine mainly showing the internal configuration.

FIG. 3 is a block diagram showing an example of the internal configuration of an image control circuit.

FIG. 4 is a diagram showing each of nine variable display portions arranged in a variable display area of a main display.

FIG. 5 is a diagram showing eight activated lines arranged in the variable display area of the main display.

FIG. 6 is a flow chart showing the operation procedure of a main control process executed repeatedly by a main CPU after power is turned on.

FIG. 7 is a flow chart showing the operation procedure of a coin insertion/start check process.

FIG. 8 is a flow chart showing the operation procedure of an internal lottery process.

FIG. 9 is a flow chart showing the operation procedure of a winning retrieve process.

FIG. 10 is a flow chart showing the operation procedure of a reel control process.

FIG. 11 is a flow chart showing the operation procedure of a free game process.

FIG. 12 is a diagram showing an example of a symbol arrangement in each variable display portion.

FIG. 13 is a diagram showing a lottery table, wherein (A) is a diagram showing a specific line lottery table and (B) is a diagram showing a free game number lottery table.

FIG. 14 is a diagram showing a symbol storage area, wherein (A) is a diagram showing an example of each variable display portion and (B) is a diagram showing an example of a specific line.

FIG. 15 is a diagram showing an example of an activated line symbol storage area.

FIG. 16 is a diagram showing an example of a winning pattern determination table.

FIG. 17 is a diagram showing an example of another winning pattern determination table.

FIG. 18 is a diagram showing an example of an effect table.

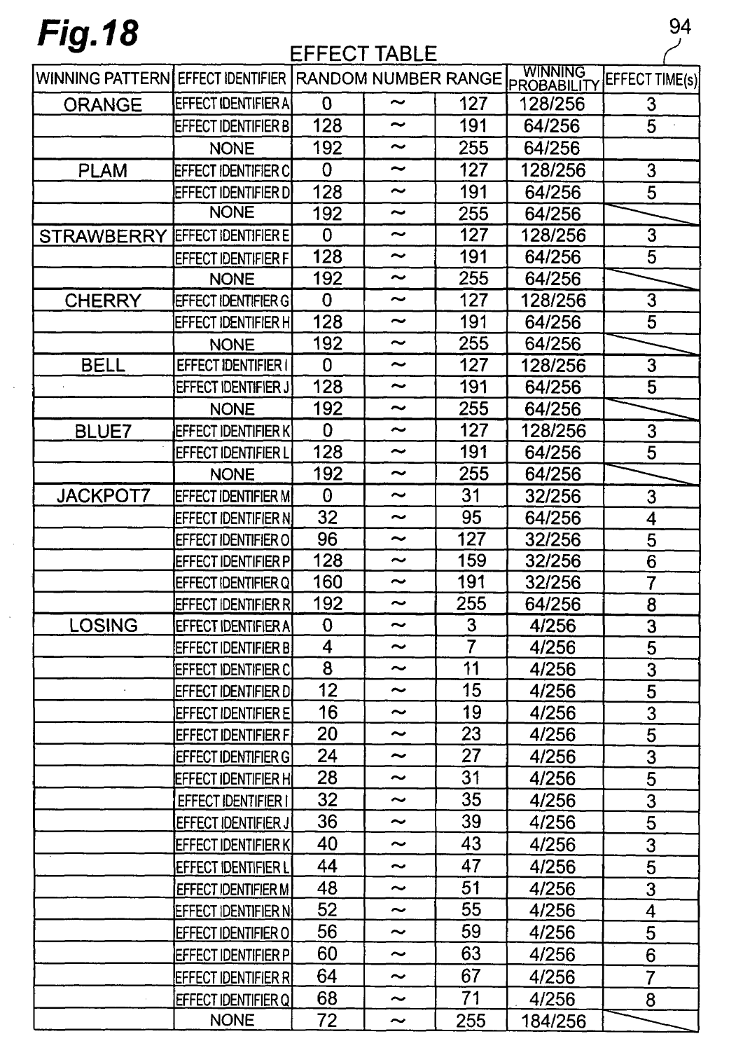

FIG. 19 is a diagram showing an example of a specific line notification image.

FIG. 20 is a diagram showing an example of the specific line notification image displayed following FIG. 19.

### DESCRIPTION OF THE PREFERRED EMBODIMENTS

Embodiments of the present invention will be described below. The same numerals and symbols are used for the same components and duplicated explanation will be omitted.

(The General Configuration of the Slot Machine)

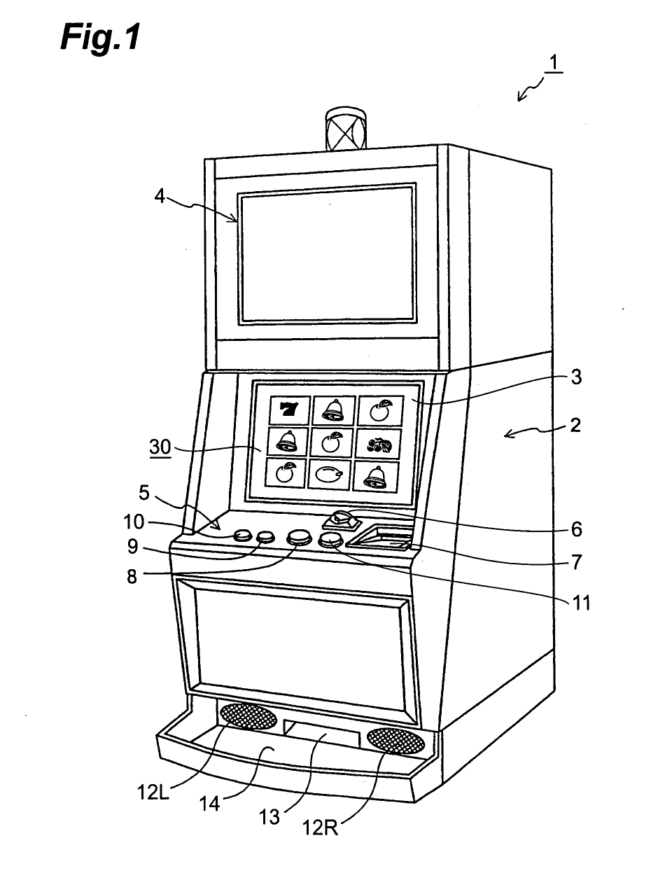

FIG. 1 is a perspective view showing the general configuration of a slot machine 1. The slot machine 1 is a gaming machine according to an embodiment of the present invention and configured so as to be capable of executing a variable display game (also referred to as a slot game) using variable display images of a plurality of symbols. The slot machine 1 has a specific game aspect in which a free game that is started under a certain condition following a base game can be executed, in addition to a base game aspect in which a base game is started unconditionally from the start of the game, and the variable display game can be executed also in the specific game aspect.

The slot machine 1 has a main display 3 (display of the present invention) including a liquid crystal display device on the front of a cabinet 2. The slot machine 1 also has a sub display 4 similarly including a liquid crystal display device on the upper part of the main display 3.

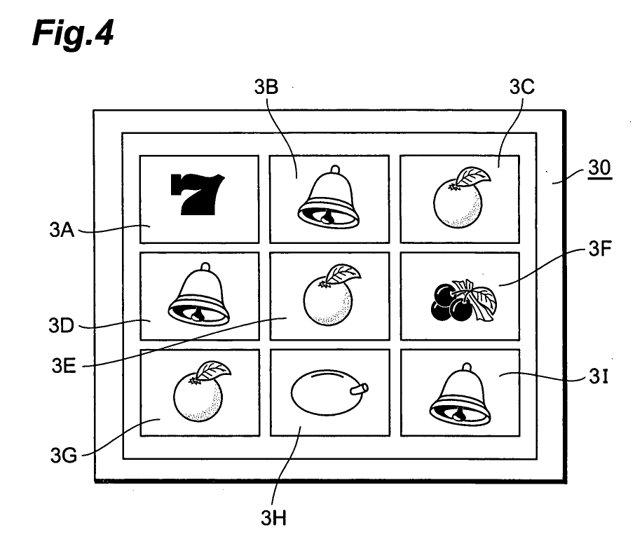

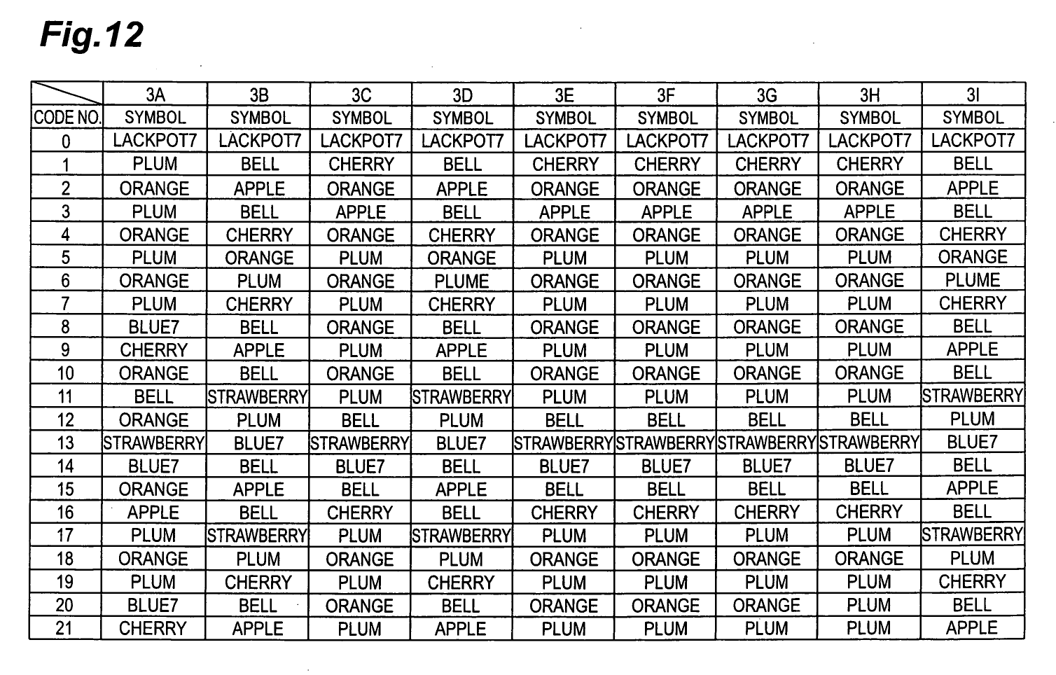

The main display 3 is an image display means of the present invention and a variable display area 30 is arranged substantially in the center of the screen. As shown in FIG. 4, the variable display area 30 has a plurality of variable display portions (in the present embodiment, a total of nine variable display portions 3A, 3B, 3C, 3D, 3E, 3F, 3G, 3H, and 3I arranged in three vertical and horizontal lines, respectively). The main display 3 is designed so that a scroll display image (a reel image displayed as if a mechanical reel were rotated) in which a plurality of symbols seem to move from the top to the bottom is displayed in each of the variable display portions 3A to 3I in the variable display area 30 both in the base game aspect and in the specific game aspect (the symbols displayed in each of the variable display portions 3A to 3I are arranged in accordance with the symbol arrangement shown in FIG. 12).

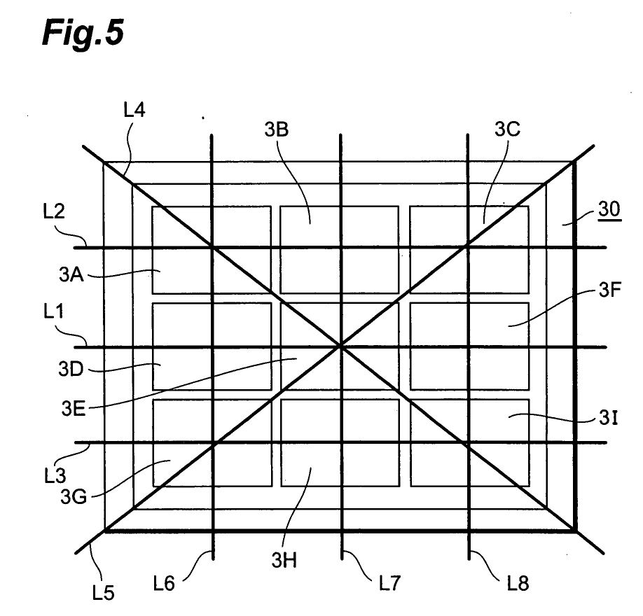

As shown in FIG. 4, since the slot machine 1 has the nine variable display portions 3A to 3I, a total of eight activated lines L1 to L8 are set, constituted by three variable display portions aligned in a straight line in the vertical, horizontal, and diagonal directions of the respective variable display portions 3A to 3I (for example, the activated line L1 is set by the three variable display portions 3D, 3E, and 3F), as shown in FIG. 5.

The sub display 4 displays a payout table and images relating to the game, such as description of the game, etc. (for example, description of the contents of the game, etc.).

Then, the slot machine 1 is provided with a substantially horizontal operation table 5 below the main display 3. On the operation table 5, a coin insertion slot 6, a bill insertion slot 7, a spin switch 8, a 1 BET switch 9, a maximum BET switch 10, and a CASHOUT switch 11 are provided.

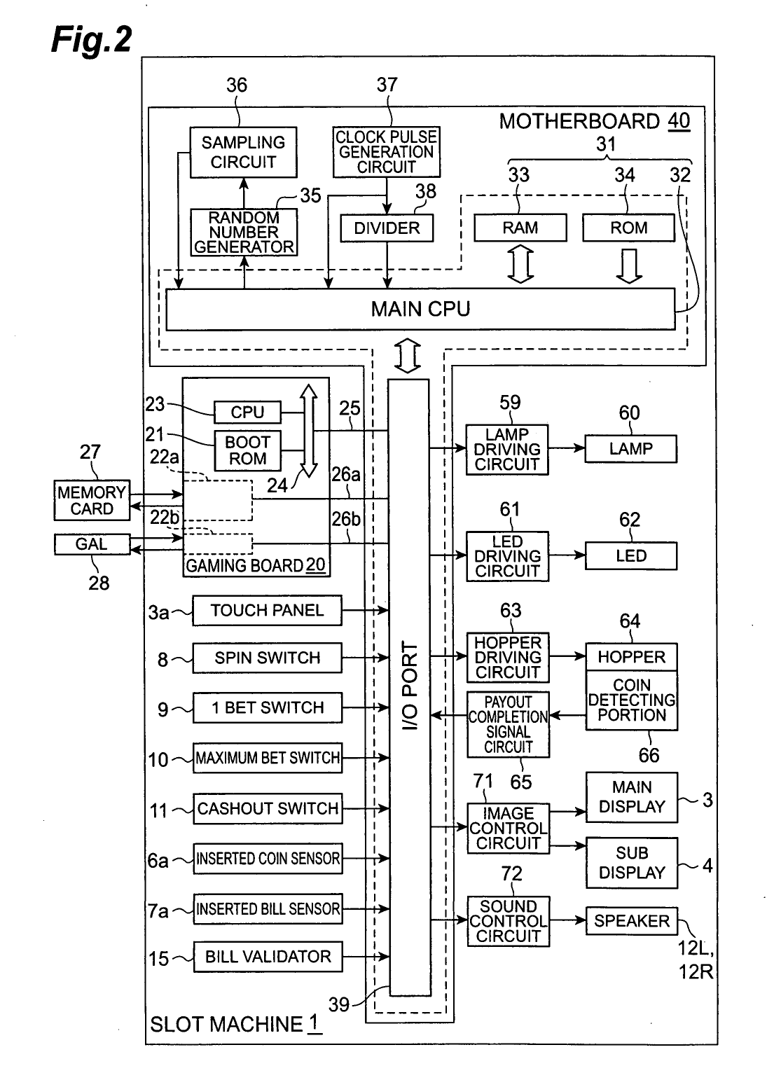

The coin insertion slot 6 is provided so that a player inserts a coin to bet on a game, having an inserted coin sensor 6a (refer to FIG. 2) that outputs a signal indicating coin insertion. The bill insertion slot 7 is provided so that a player inserts a bill, having an inserted bill sensor 7a (refer to FIG. 2) that outputs a signal indicating bill insertion. The spin switch 8 is provided so that a player performs an operation to start a slot game by displaying a scroll display image of symbols on each of the variable display portions 3A to 3I. The 1 BET switch 9 is provided in order to perform a setting to bet one coin by one-time operation. The maximum BET switch 10 is provided in order to perform a setting to bet the maximum number of coins that can be bet on one game by one-time operation. The CASHOUT switch 11 is an operation button in order to pay out coins that can be paid out.

Further, the slot machine 1 is provided with a coin payout opening 13 and a coin receiving portion 14 for receiving coins paid out at the bottom of the cabinet 2. Furthermore, speakers 12L and 12R are provided on the left side and the right side, respectively, sandwiching the coin payout opening 13 therebetween.

FIG. 2 is a block diagram of the slot machine 1, mainly showing the internal configuration. The slot machine 1 has a plurality of components with a gaming board 20 and a motherboard 40 as the central components.

The gaming board 20 has a CPU 23 and a boot ROM 21 connected to each other by an internal bus 24 and card slots 22a and 22b corresponding to a memory card 27 and a GAL 28, respectively, and is a device that reads a game program and a game system program to be described later from the memory card 27 and reads the coin payout rate setting data from the GAL 28 into the motherboard 40.

The CPU 23 and the boot ROM 21 connected to each other by the internal bus 24 are connected to the motherboard 40 by a PCI bus 25. The PCI bus 25 transmits signals between the motherboard 40 and the gaming board 20 and supplies electric power from the motherboard 40 to the gaming board 20. In the boot ROM 21, an authentication program, a preliminary authentication program, and a program (boot code), not shown, by which the CPU 23 boots (activates) the preliminary authentication program, etc., to be described later, are stored.

The authentication program is a program to check and prove that information for the game, for which authentication read process is executed, has not been altered, that is, a program written in accordance with a procedure to execute authentication of information for a game (authentication procedure) and by which a main CPU 32 (processor of the present invention), to be described later, authenticates the game program and the game system program supplied to the slot machine 1 using the memory card 27. The authentication program is also referred to as an alteration check program because it checks that the game program and the game system program have not been altered.

The preliminary authentication program is a program to check and prove that the above-mentioned authentication program is not altered, that is, a program described in accordance with a procedure to execute authentication of an authentication program (authentication procedure), authenticating the above-mentioned authentication program for authenticating the game program and the game system program. The preliminary authentication program is executed by the CPU 23.

The card slot 22a is connected to the motherboard 40 via an IDE bus 26a. The card slot 22a is designed so as to be capable of connecting the memory card 27 in a state in which the stored game program and game system program can be read, being a slot (physical connection portion) into which a memory card can be inserted.

The card slot 22b is connected to the motherboard 40 via an IDE bus 26b. The card slot 22b is designed so as to be capable of connecting the GAL 28 in a state in which the stored payout rate setting data can be read, being a slot (physical connection portion) into which the GAL 28 can be inserted.

The motherboard 40 is configured using a commercial general-purpose motherboard (a printed board mounting basic parts of a personal computer), and has at least a main CPU (Central Processing Unit) 32 (processor of the present invention), a ROM (Read Only Memory) 34, a RAM (Random Access Memory) 33, and an I/O port 39, further having a random number generator 35, a sampling circuit 36, a clock pulse generation circuit 37, and a divider 38. Then, to the I/O port 39, the PCI bus 25 and the IDE buses 26a and 26b, described above, are connected.

The main CPU 32 operates, on one hand, as various kinds of means characterizing the present invention in accordance with the read game program and game system program, and on the other hand, executes input/output of signals with other components via the I/O port 39 and executes the operation control of the entire slot machine 1. The RAM 33 stores data or programs used when the main CPU 32 operates, storing at least the authentication program, the game program, and the game system program read via the gaming board 20.

The ROM 34 stores programs, such as the BIOS (Basic Input/Output System, the standard BIOS on the motherboard 40), and permanent data. When the BIOS is executed by the main CPU 32, the predetermined initialization process of the peripheral devices is executed and at the same time, the read process of the game program and the game system program stored in the memory card 27 via the gaming board 20 is started. Incidentally, as the ROM 34, a memory device, such as a flash memory etc., is employed, however, both the device whose contents are rewritable and that not rewritable may be used.

In addition, the random number generator 35 generates random numbers in a certain range by the operation in accordance with the instruction of the main CPU 32. The sampling circuit 36 extracts an arbitrary random number from among the random numbers generated by the random number generator 35 in accordance with the instruction of the main CPU 32 and inputs the extracted random number in the main CPU 32. The clock pulse generation circuit 37 generates a reference clock to operate the main CPU 32 and the divider 38 inputs a signal, which is the reference clock divided at a fixed period, to the main CPU 32.

Further, the slot machine 1 has a touch panel 3a, a lamp driving circuit 59, a lamp 60, an LED driving circuit 61, an LED 62, a hopper driving circuit 63, a hopper 64, a payout completion signal circuit 65, and a coin detecting portion 66. The slot machine 1 also has an image control circuit 71 and a sound control circuit 72.

The touch panel 3a is provided so as to cover the display screen of the main display 3, detects the position of a part touched by the finger etc. of a player, and inputs the position signal corresponding to the detected position to the main CPU 32. With the touch panel 3a, the player can perform the input operation by the touching operation of the finger etc. and the touch panel 3a has the function as an operation input means. The lamp driving circuit 59 outputs a signal to light up the lamp 60 to the lamp 60 and causes the lamp 60 to blink during the execution of a game. Using this blinking, the effect of the game is executed. The LED driving circuit 61 controls the blinking display of the LED 62. The LED 62 produces a display of the number of credits, a display of the number of obtained credits. The hopper driving circuit 63 drives the hopper 64 in accordance with the control of the main CPU 32 and the hopper 64 executes an operation to pay out coins and causes coins to be paid out from the coin payout opening 13 onto the coin receiving portion 14. The coin detecting portion 66 counts the number of coins paid out by the hopper 64 and notifies the payout completion signal circuit 65 of the data of the counted number of coins. The payout completion signal circuit 65 receives the data of the number of coins from the coin detecting portion 66, and inputs a signal for the notification of the completion of payout of coins to the main CPU 32 when the number of coins reaches the set data of the number of coins.

The image control circuit 71 displays various images, such as variable display images of a plurality of symbols, specific line notification images 100 and 101, to be described later, etc., on the main display 3 and the sub display 4 by controlling the image display on the main display 3 and the sub display 4, respectively.

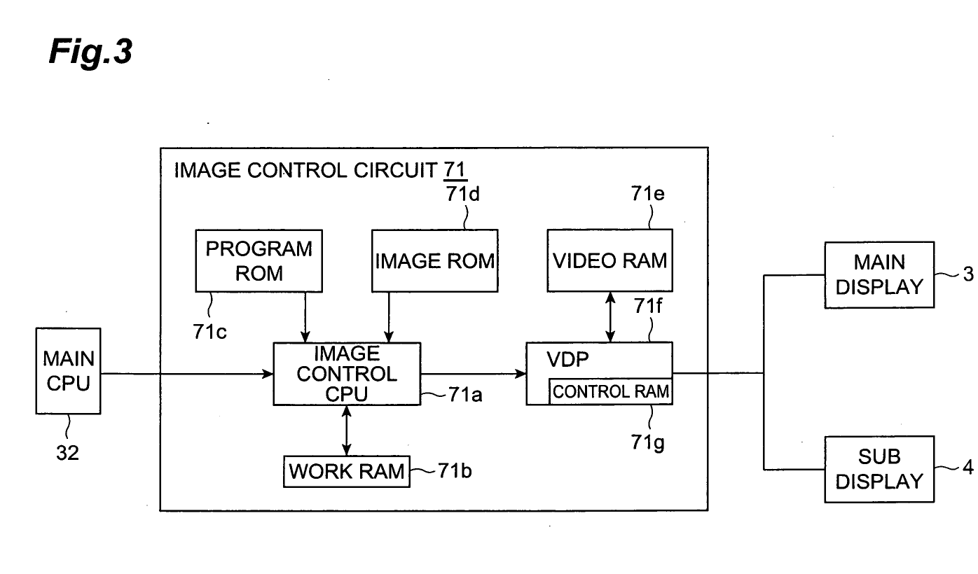

As shown in FIG. 3, the image control circuit 71 has an image control CPU 71a, a work RAM 71b, a program ROM 71c, an image ROM 71d, a video RAM 71e, and a VDP (Video Display Processor) 71f. The image control CPU 71a determines an image (reel images, images of stopped symbols displayed when the scroll display stops, etc.) to be displayed on the main display 3 and the sub display 4 in accordance with the image control program (relating to the display on the main display 3 and the sub display 4) stored in advance in the program ROM 71c based on the parameter set in the main CPU 32. The work RAM 71b is configured as a temporary storage means when the image control CPU 71a executes the image control program.

The program ROM 71c stores image control programs and various selection tables. The image ROM 71d stores dot data for forming an image. The dot data includes symbol image data indicative of each symbol used in the base game and free game in the present embodiment. The video RAM 71e is configured as a temporary storage means when an image is formed by the VDP 71f. The VDP 71f has a control RAM 71g, forms an image corresponding to the display contents of the main display 3 and the sub display 4 determined by the image control CPU 71a, and outputs the formed image to the main display 3 and the sub display 4.

The sound control circuit 72 inputs a sound signal to cause speakers 12L and 12R to output sound to the speakers 12L and 12R. From the speakers 12L and 12R, sound for enlivening the game is output with proper timing after the game is started.

(The Operation Contents of the Slot Machine)

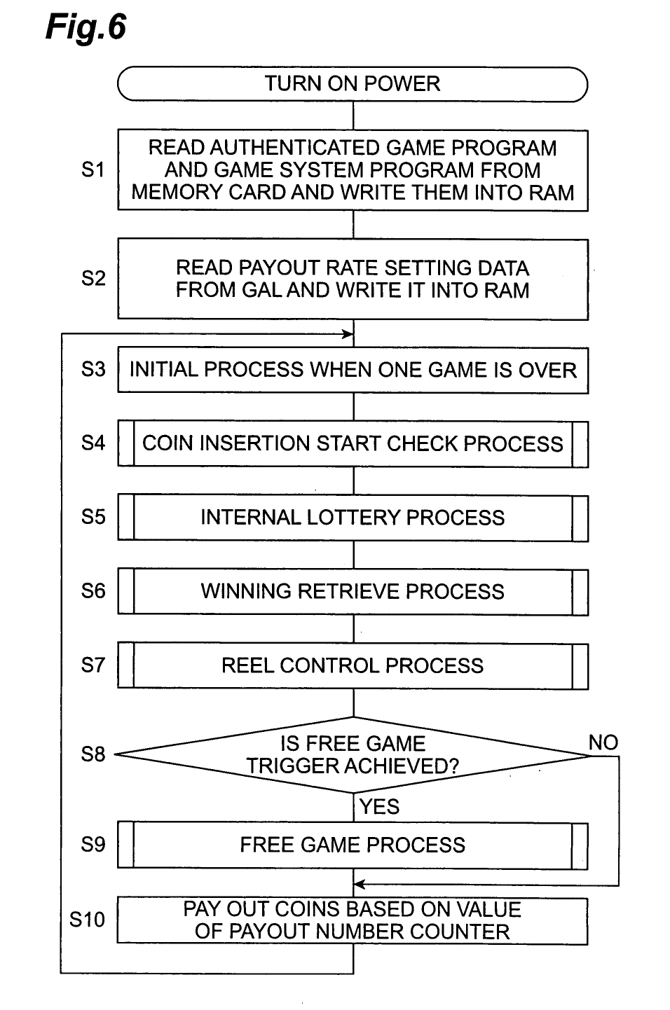

Next, the operation contents of the slot machine 1 having the above configuration will be described with reference to the flow charts shown in FIG. 6 to FIG. 11. FIG. 6 is a flow chart (main flow chart) showing the operation procedure of the main control process executed repeatedly by the main CPU 32 after power is turned on in the slot machine 1. In FIG. 6 to FIG. 11, step is abbreviated to S.

(The Operation Procedure of the Main Control Process)

As shown in FIG. 6, in the slot machine 1, the main CPU 32 operates as a game progress control means and controls the progress of the slot game. When starting the main control process following the power-on, the main CPU 32 proceeds to step 3 after executing steps 1 and 2 and enters a repetition routine in which each of steps 3 to 10 is repeatedly executed sequentially.

In the slot machine 1, in step 1, the main CPU 32 executes the BIOS stored in the ROM 34, reads the authentication program from the boot ROM 21 and causes the RAM 33 to store it, executes the authentication process of the game program and game system program stored in the memory card 27 in accordance with the authentication program, reads the game program and game system program via the gaming board 20, and executes the read process for writing the read game program and game system program in the RAM 33. Following this, the main CPU 32 proceeds to step 2, executes the read process for reading the payout rate setting data stored in the GAL 28 via the gaming board 20, and writes the read payout rate setting data in the RAM 33.

Following this, in step 3, the initialization process for starting the next game is executed. This initialization process is executed each time the slot game is over and a process, such as clearing of the data of the items set in a predetermined data area (for example, a specific line code to be described later, a payout number counter to be described later, etc.), is executed. Next, in step 4 to step 7, a coin insertion/start check process, an internal lottery process, a winning retrieve process, and a reel control process are executed in order, however, here, the base game is executed and the current game aspect is the base game aspect.

Next, in step 8, when a free game trigger, which will be described later, is achieved during the base game and the condition of shifting to a specific game aspect is met, the main CPU 32 operates as a shifting means, shifts the game aspect from the base game aspect to the specific game aspect, proceeds to step 9, and proceeds to step 10 after executing a free game process in step 9, which will be described later. However, when the condition of shift is not met, the main CPU 32 proceeds to step 10 without executing step 9. In step 10, the main CPU 32 instructs the hopper driving circuit 63 to cause coins in the number corresponding to the payout number counter to be paid out from the hopper 64.

(The Coin Insertion/Start Check Process)

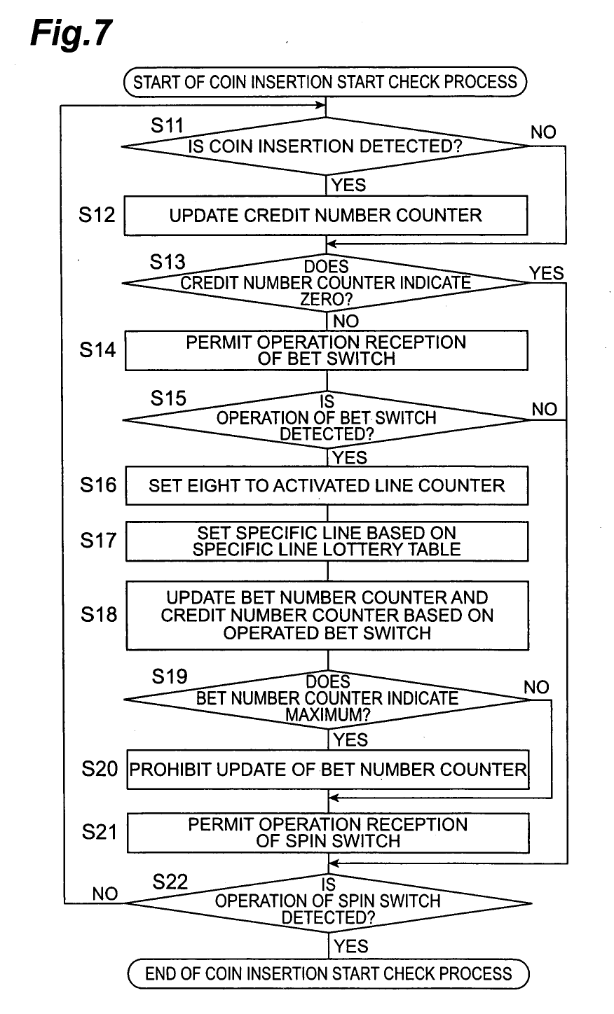

The coin insertion/start check process in step 4 is executed along the flow chart shown in FIG. 7. When starting the coin insertion/start check process, the main CPU 32 proceeds to step 11, determines whether or not coin insertion is detected depending on whether or not a signal from the inserted coin sensor 6a is input, and proceeds to step 12 and then to step 13 after executing step 12 when coin insertion is detected. However, when coin insertion is not detected, the CPU 32 proceeds to step 13 without executing step 12. In step 12, the CPU 32 updates a credit number counter (addition is carried out depending on inserted coins) indicative of the number of credits composed of inserted coins or coins to be paid out. Then, in step S13, the CPU 32 determines whether or not the credit number counter indicates zero and when zero, the CPU 32 proceeds to step 22, otherwise to step 14. In step 14, the CPU 32 permits the operation reception of the BET switches (the 1 BET switch 9 and the maximum BET switch 10).

Next, in step 15, the main CPU 32 determines whether or not the operation of the BET switches (the 1 BET switch 9 and the maximum BET switch 10) is detected and when either operation is detected, the main CPU 32 proceeds to step 16, or proceeds to step 22 when neither operation is detected. In step 16, the main CPU 32 operates as a line setting means of the present invention and sets the activated line counter indicating the number of set activated lines to “eight” so that even when only one coin is inserted, all of the eight activated lines L1 to L8 are set (that is, all of the eight activated lines L1 to L8 are all activated and line-pay, which will be described later, is enabled for all of the activated lines L1 to L8).

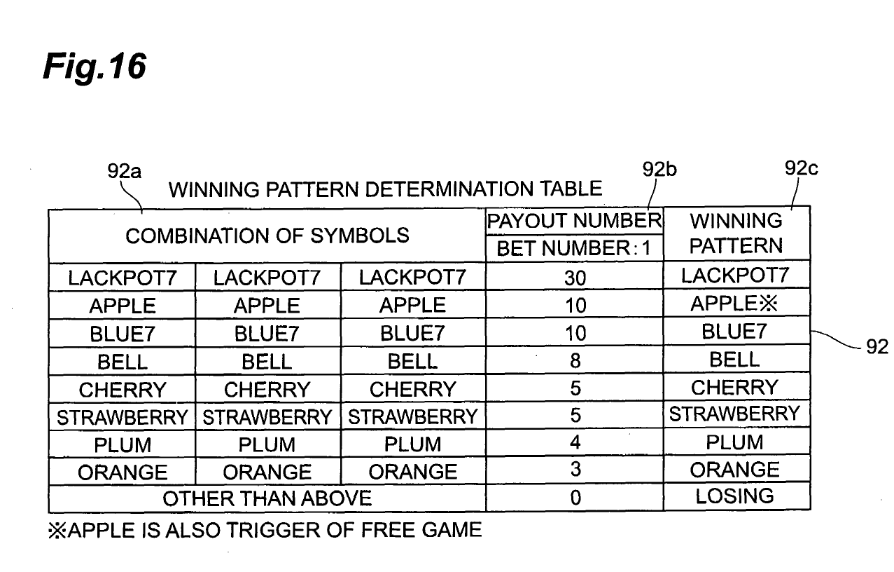

In the next step 17, the main CPU 32 operates as a specific line setting means of the present invention and sets a specific line using three variable display portions that align in a straight line like the activated lines L1 to L8. In this case, since any one of the eight activated lines L1 to L8 is set as a specific line, the main CPU 32 executes a specific line lottery, which will be described later, and sets a specific line based on the lottery result. While for the eight activated lines L1 to L8 before a specific line is set and the remaining seven activated lines except for the specific line, the amount (the payout number) of game award (payout of coins, in the present embodiment) provided to a player is determined by line-pay, for the specific line, it is determined by any-pay. While for the line-pay, payout of coin is made based on a combination of three symbols (that is, when the same three symbols are aligned) displayed in a stopped state on each of the variable display portions arranged along each of the activated lines L1 to L8, for the any-pay, payout of coin is made based on at least one symbol on the specific line (based on the individual symbols, even though the same three symbols are not aligned). The symbols in this case are those constituting a winning pattern (refer to FIG. 16), and therefore, when at least one of the symbols constituting the winning pattern is displayed in a stopped state on the specific line, payout of coin is made. Because of this, the any-pay is more likely to make payout than the line-pay (the probability of payout is higher) and therefore more advantageous for a player, and in addition, the number of coins to be paid out is larger (to be described in detail later). As a result, when the specific line is set, the specific game award more likely to be provided than the game award is provided to a player.

The specific line thus set is also called a mystery line because it may happen that the player recognizes the specific line as a mysterious line with a different condition of payout of coin and a different amount of award, although its appearance is the same as that of the other activated lines.

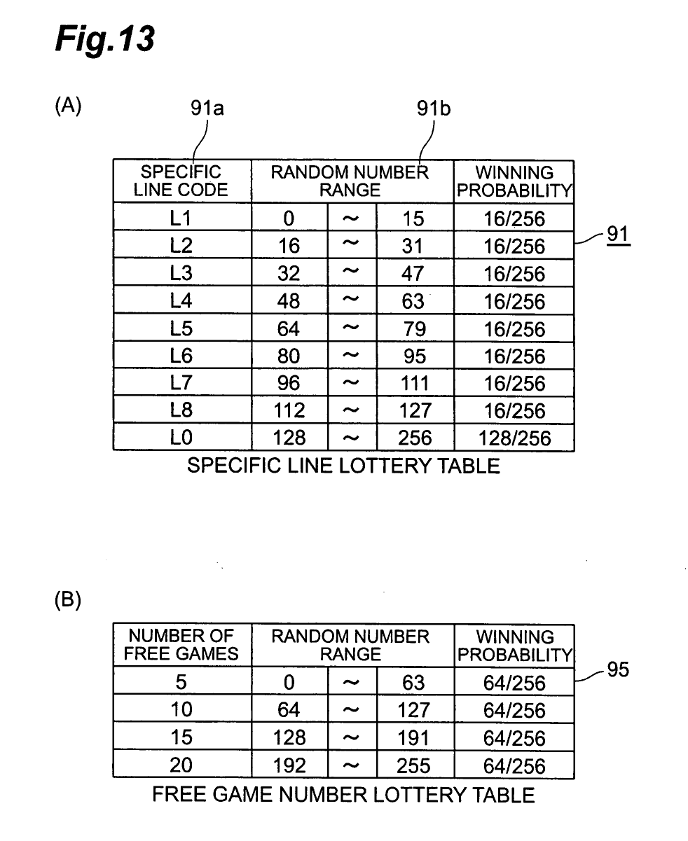

In the case of the present embodiment, the main CPU 32 executes the lottery of the specific line as follows. That is, the CPU 32 instructs the random number generator 35 to generate random numbers in a certain range and instructs the sampling circuit 36 to extract an arbitrary random number from among the random numbers generated by the random number generator 35. Then, the main CPU 32 searches a specific line lottery table 91 shown in FIG. 13(A), which will be described later, using the extracted random number and determines whether or not a specific line needs to be set based on the search result. On the other hand, the CPU 32 sets a specific line when a setting condition for setting a specific line is met (when a specific line code, to be described later, is not “L0”). It may also be possible to execute a lottery in which it is determined that the specific line needs to be set by a predetermined probability, in addition to the execution of the specific line lottery using the specific line lottery table 91, and to set the specific line when the result of the determination is that the specific line needs to be set and the setting condition is met.

Then, in step 18, the main CPU 32 updates the BET number counter indicating the number of bet coins and the credit number counter (the number of bet coins is added, and the credit number counter is decremented) based on the BET switches the operation of which has been detected, and in the following step 19, determines whether or not the BET number counter indicates its maximum. When the BET number counter indicates its maximum, the main CPU 32 proceeds to step 20 to execute a process to prohibit the update of the BET number counter and proceeds to step 21, otherwise proceeds to step 21 without executing step 20. In step 21, the main CPU 32 permits the operation reception of the spin switch 8 and in the following step 22, the main CPU 32 determines whether or not the operation of the spin switch 8 is detected, and terminates the coin insertion/start check process when the operation of the spin switch 8 is detected, otherwise returns to step 11 and executes the above-mentioned process repeatedly.

(The Internal Lottery Process)

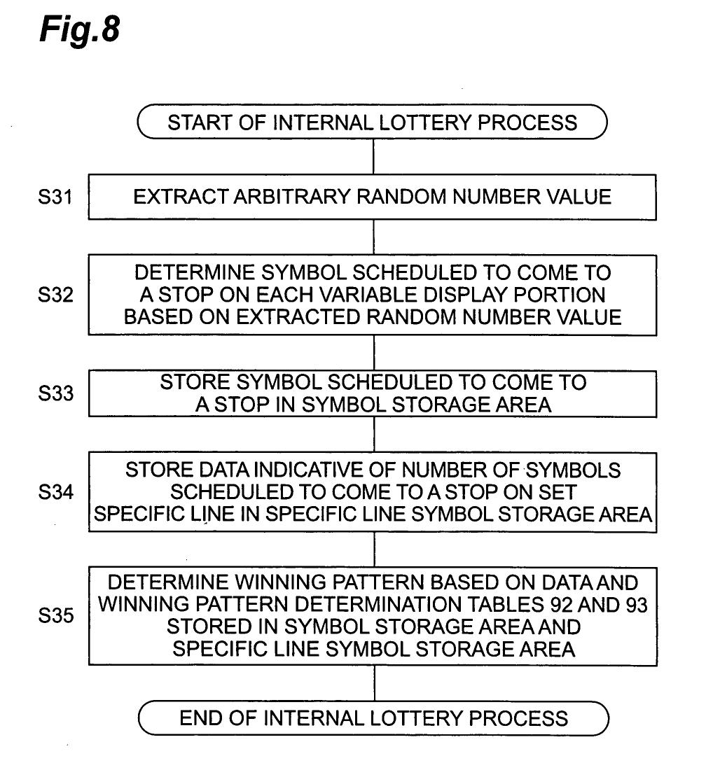

When the coin insertion process is terminated, the main CPU 32 proceeds to step 5 back in FIG. 6 and executes an internal lottery process. The main CPU 32 executes the internal lottery process along the flow chart shown in FIG. 8.

When starting the internal lottery process, the main CPU 32 proceeds to step 31 and instructs the sampling circuit 36 to extract an arbitrary random number from among the random numbers generated by the random number generator 35. In the following step 32, the main CPU 32 operates as a symbol determination means and determines symbols to be displayed in a stopped state on each of the variable display portions 3A to 3I (symbols scheduled to come to a stop) based on the random number extracted in step 31. In this case, the extraction of a random number is executed nine times in accordance with the respective variable display portions 3A to 3I, and determination of a symbol scheduled to come to a stop is also made nine times in accordance with the respective variable display portions 3A to 3I.

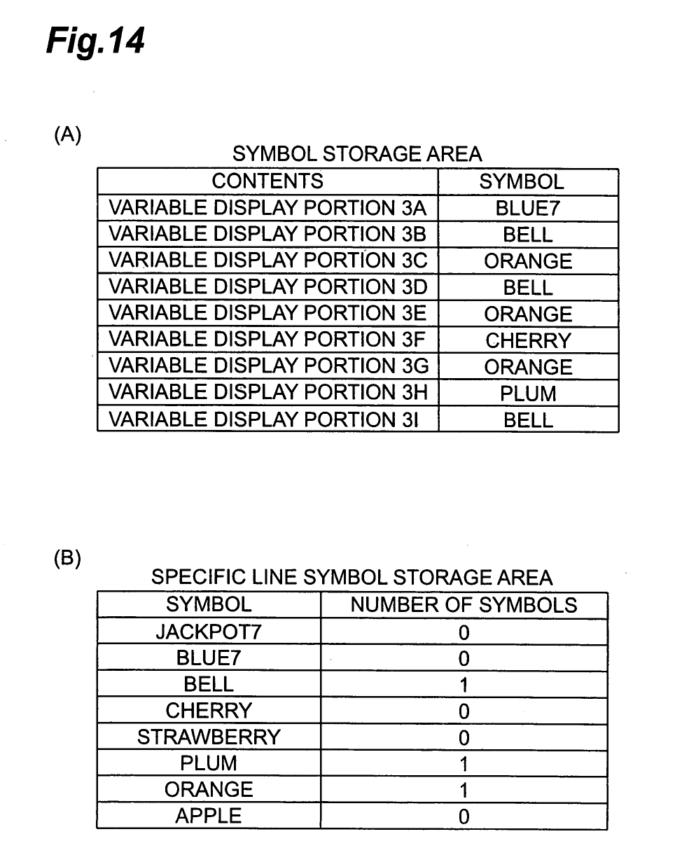

Next, in step 33, the main CPU 32 stores the data (data for identifying a symbol is referred to as symbol data) of symbols scheduled to come to a stop determined in step 32 in a symbol storage area reserved in the RAM 33. In the symbol storage area, the symbol data is stored in a manner, for example, as shown in FIG. 14(A) (FIG. 14(A) shows an example when the stop control position in FIG. 12 is the code No 20). In addition, in the subsequent step 34, the main CPU 32 stores data (data of the number of symbols) indicative of the number of symbols scheduled to come to a stop on the variable display portions arranged along the specific line determined in step 19 in a specific line symbol storage area reserved in the RAM 33. In the specific line symbol storage area, the data of the number of symbols is stored in a manner, for example, as shown in FIG. 14(B). For example, when the specific line is set by the same three variable display portions as those of the activated line L3 (in this case, the variable display portions are 3G, 3H, and 3I) and the stop control position is the code No 20, the symbols scheduled to come to a stop are “ORANGE”, “PLUM”, and “BELL” from FIG. 12, and therefore, the data of the number of symbols is “one”, respectively, and others are “zero” in FIG. 14(B). Further, in step 35, the main CPU 32 searches winning pattern determination tables 92 and 93, to be described later, using the symbol data and the data of the number of symbols stored in the symbol storage area and the specific line symbol storage area of the RAM 33 and determines winning patterns therefrom, respectively.

(The Winning Retrieve Process)

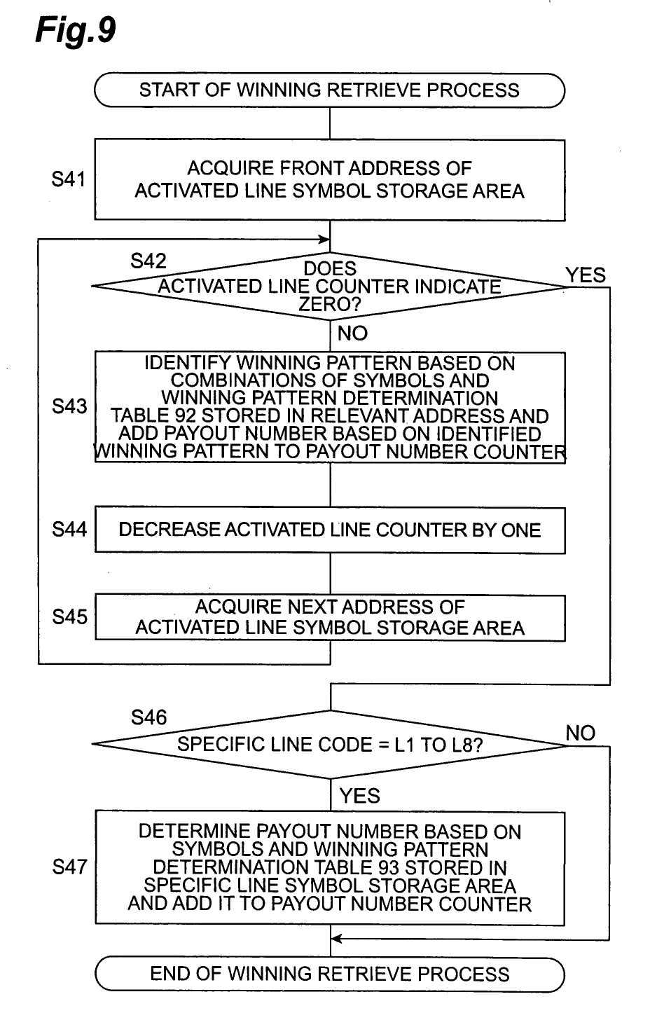

When the internal lottery process is terminated, the main CPU 32 proceeds to step 6 back in FIG. 6, and executes a winning retrieve process. The main CPU 32 executes the winning retrieve process along the flow chart shown in FIG. 9.

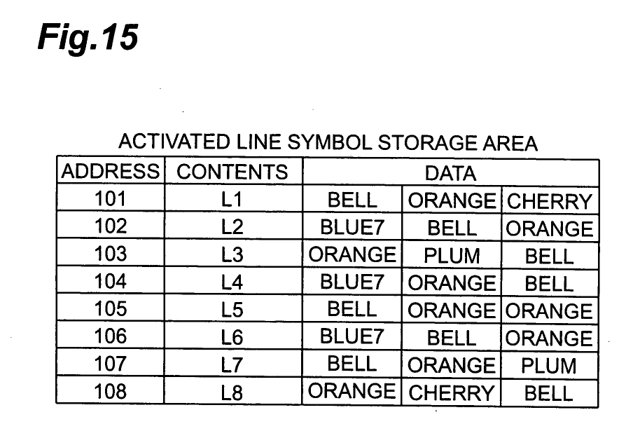

When starting the winning retrieve process, the main CPU 32 proceeds to step 14 and acquires the front address of an activated line symbol storage area (area in which symbol data of symbols scheduled to come to a stop on each variable display portion is stored for each activated line) shown in FIG. 15 and in the next step 42, determines whether or not the activated line counter indicates “zero”. Here, when it is not determined that the activated line counter indicates “zero”, the main CPU 32 proceeds to step 43 and returns to step 42 after executing steps 43, 44, and 45 in order. However, when it is determined that the activated line counter indicates “zero”, the main CPU 32 proceeds to step 46 without executing steps 43, 44, and 45.

In step 43, the main CPU 32 operates as an award determination means and identifies a corresponding winning pattern by using a combination of symbol data corresponding to the acquired front address in the activated line symbol storage area and searching the winning pattern determination table 92, to be described later. On the other hand, the main CPU 32 determines the payout number (the amount of game award of the present invention) based on the identified winning pattern. In addition, the determined payout number is added to the payout number counter. In the next step 44, the main CPU 32 decreases the activated line counter by “one” and in the following step 45, acquires the next address of the activated line symbol storage area. After executing step 45, the main CPU 32 returns to step 42 and executes steps 42 to 45 in the manner as described above.

Then, in step 46, the main CPU 32 determines whether or not the specific line code is any one of “L1” to “L8” and proceeds to step 47 when the code is any one of “L1” to “L8”, and terminates the winning retrieve process after executing step 47. Otherwise, the main CPU 32 terminates the winning retrieve process without executing step 47. In step 47, the main CPU 32 operates as s specific award determination means of the present invention and determines the payout number (the amount of specific game award in the present invention) by searching the winning pattern determination table 93, to be described later, using the data of the number of symbols stored in the specific line symbol storage area and adds the determined payout number to the payout number counter.

(The Reel Control Process)

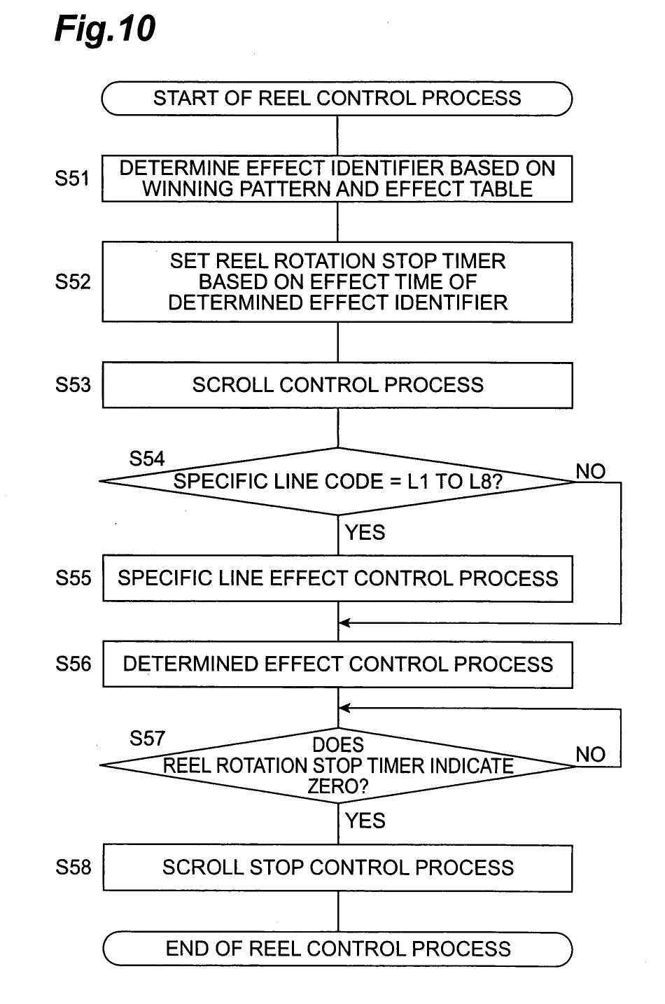

When terminating the winning retrieve process, the main CPU 32 proceeds to step 7 back in FIG. 6 and executes a reel control process. The main CPU 32 executes the reel control process along the flow chart shown in FIG. 10.

When starting the reel control process, the main CPU 32 proceeds to step 51 and determines an effect identifier based on the winning pattern and an effect table 94, to be described later. In the following step 52, the main CPU 32 sets a reel rotation stop timer based on an effect time indicated by the effect identifier determined in step 51 and executes a scroll control process in the following step 53. At this time, the main CPU 32 instructs the image control circuit 71 to display a scroll display image on each of the variable display portions 3A to 3I. Following this, in step 54, the main CPU 32 determines whether or not the specific line code is any one of “L1” to “L8” and proceeds to steps 55 when the code is any one of “L1” to “L8”, and proceeds to step 56 after executing step 55. Otherwise, the main CPU 32 proceeds to step 56 without executing step 55.

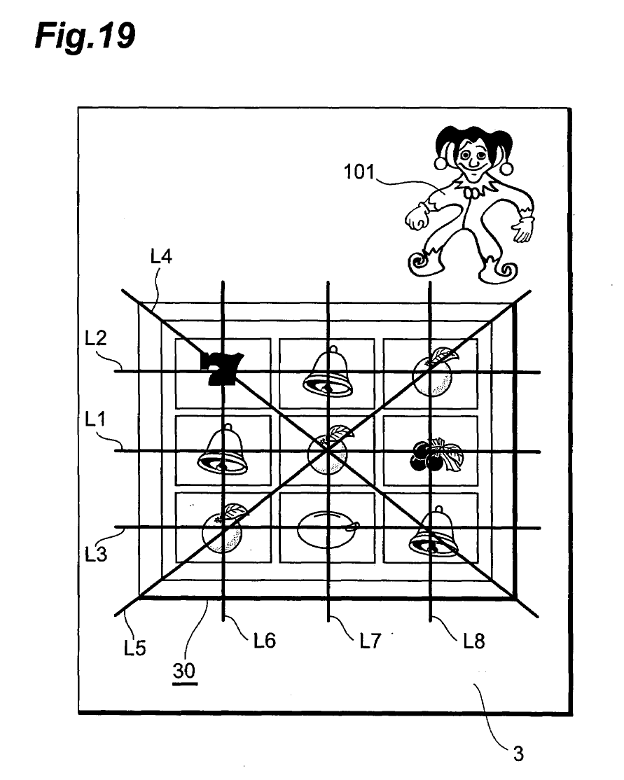

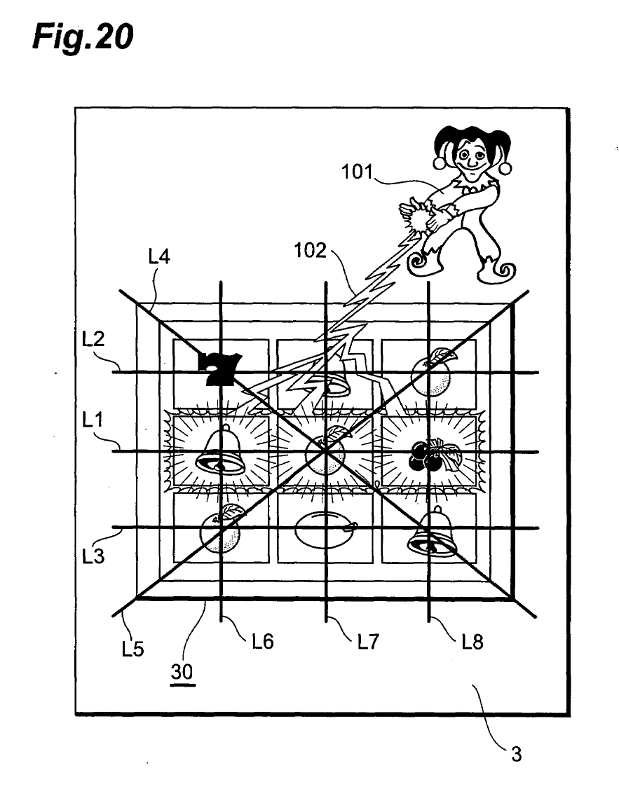

In step 55, the main CPU 32 operates as a notification image display control means and executes a specific line effect control process by instructing the image control circuit 71 to display specific line notification images 100 and 101 for the notification of the specific line to the player. As shown in FIGS. 19 and 20, the specific line notification images 100 and 101 are such images in which a joker 101 appears from the depths in the screen and discharges lightning 102 from his finger tips and the lightning 102 indicates the specific line (in FIG. 20, the activated line L1).

In step 56, main CPU 32 executes the determined effect control process and instructs the image control circuit 71 to display the effect image. In addition, in the following step 57, the main CPU 32 stands by until the reel rotation stop timer indicates “zero” and proceeds to step 58 when it indicates “zero ” and instructs the image control circuit 71 to display an image in which the scrolling of the scroll display image stops on each of the variable display portions 3A to 3I. In addition, after executing step 58, the main CPU 32 terminates the real control process.

(The Free Game Process)

In step 8, when it is determined that the free game trigger has been achieved, the free game process is started. In the present embodiment, it is determined that the free game trigger is achieved when the three specific symbols (apple) aligns on the activated line (however, another condition may be accepted).

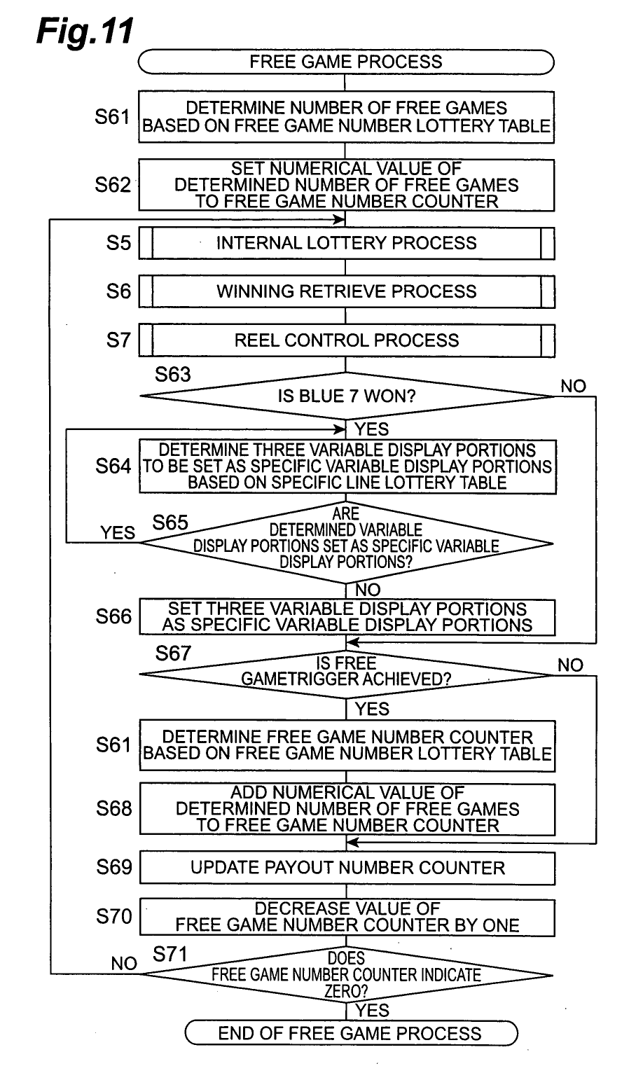

Then, the free game process is executed along the flow chart shown in FIG. 11. When starting the free game process, the main CPU 32 proceeds to step 61, refers to the free game number lottery table 95 shown in FIG. 13(B), to be described later, using the extracted random number, and determines the number of free games (the number of times the free game is repeated). Next, in step 62, the main CPU 32 sets the number of free games determined in step 61 to the free game number counter. After that, as the above, that is, in the same manner as that in the base game aspect, after executing steps 5, 6, and 7, the main CPU 32 proceeds to step 63.

In step 63, the main CPU 32 determines whether or not the specific condition is met, which is determined by the symbol to be displayed in a stopped state on at least one of the plurality of the variable display portions 3A to 3I. Here, whether or not the specific condition is met is determined depending on whether or not BLUE 7 is won (whether or not the symbol of the number “7” displayed in blue has been displayed in a stopped state along any one of the activated lines L1 to L8). Then, when BLUE 7 is won and it is determined that the specific condition is met, the main CPU 32 proceeds to step 64 and after executing steps 64, 65, and 66, proceeds to step 67. Otherwise, the main CPU 32 proceeds to step 67 without executing steps 64, 65, and 66.

In step 64, the main CPU 32 operates as the determination means and determines three variable display portions (variable display portions for setting) to be set as the specific variable display portions (variable display portions more likely to make payout than the variable display portions other than the specific variable display portions and relatively advantageous for a player) from among the nine variable display portions. In step 64, the main CPU 32 searches the above-mentioned specific line lottery table 91 using the random number extracted by the main CPU 32 and determines three variable display portions constituting any one of the activated lines L1 to L8 as the variable display portions for setting. For example, when the line code L1 corresponds to the random number, the variable display portions 3D, 3E, and 3F are determined as the variable display portions for setting. In step 65, the main CPU 32 determines whether or not the three variable display portions for setting determined in step 64 are already set as the specific variable display portions and when they are already set as the specific variable display portions, the main CPU 32 returns to step 64 and determines again three variable display portions by the same random number lottery as the above. Otherwise, the main CPU 32 proceeds to step 66. In step 66, the main CPU 32 operates as the specific variable display portion setting means of the present invention and sets the three variable display portions determined in step 64 as the specific variable display portions. When the three variable display portions are set as the specific variable display portions in this manner, as with the case where the above-described specific line is set, for the variable display portions for which the payout number has been determined by the line-pay so far, the payout number will be determined by the any-pay from now on.

In addition, when the three variable display portions determined as above are already set as the specific variable display portions, the main CPU 32 operates as the variation control means in the present invention and returns to step 64 from step 65 and determines again three variable display portions, controlling the number of specific variable display portions to increase by causing steps 64 and 65 to be executed repeatedly until other variable display portions not set as the specific variable display portions are determined. Because of this, it is unlikely that the variable display portions already set as the specific variable display portions are set again as the specific variable display portions even if BLUE 7 is won and it is determined that the specific condition has been met. In this manner, by controlling the specific variable display portions to be set by other variable display portions not set as the specific variable display portions, the number of specific variable display portions increases and thereby the setting to increase the number of specific lines is executed, by which the number of specific lines increase while the specific lines are being added. In this case, it is designed so that the number of specific lines increases from the free game next to the free game in which BLUE 7 has been won (the specific line set to be added is reflected in the internal lottery process from the next free game).

After step 66, the main CPU 32 proceeds to step 67 and determines whether or not the free game trigger has been achieved, as in step 8. Here, when it is determined that the free game trigger has been achieved, the main CPU 32 executes step 68 after executing step 61 in the same manner as the above, and proceeds to step 69. Otherwise, the main CPU 32 proceeds to step 69 without executing steps 61 and 68. Here, when the free game trigger has been achieved, step 61 is executed again and the number of free games is determined, and the determined number of free games is added to the free game number counter in step 68. Consequently, when the free game trigger is achieved during the free game, the free game number counter is increased each time.

Then, in step 69, the main CPU 32 updates the value of the payout number counter and in the following step 70, reduces the value of the free game number counter by “one” and in the next step 71, determines whether or not the free game number counter indicates “zero” and when “zero”, the main CPU 32 terminates the free game process, otherwise, returns to step 5.

As described above, the free game process is configured so that the free game is executed repeatedly until the value of the free game number counter determined in step 61 and added in step 68 indicates “zero” (corresponding to the number of times of the free game number counter).

When the specific line is set in step 19 of the coin insertion process in the base game, the main CPU 32, when entering the specific game aspect without returning to step 3 from step 10, executes the free game process with the specific line still set. Because of this, the specific line set in the base game is taken over in the free game and the free game is executed with the specific line remaining effective.

(Explanation of the Table)

As shown in FIG. 13(A), the specific line lottery table 91 has a specific line code area 91a and a random number area 91b and the specific line code indicative of a specific line and the random number are associated with each other and stored and the respective activated lines L1 to L8 are selected with respective predetermined probabilities by the search of the specific line code area 91a and in this case, any one of the activated lines L1 to L8 is set as a specific line with a predetermined probability. The specific line code “L0” indicates the case where the specific line is not set, that is, losing.

As shown in FIG. 16, the winning pattern determination table 92 has a symbol code area 92a, a payout number area 92b, and a winning pattern area 92c and the payout number and the winning pattern are determined based on the combination of the symbol codes of the symbols scheduled to come to a stop, which are displayed in a stopped state on the three variable display portions arranged along the activated line. In other words, the symbol code area 92a is searched using the combination of the symbol codes of the symbols scheduled to come to a stop, which are displayed in a stopped state on the three variable display portions and when a relevant combination is encountered, the payout number and the winning pattern set by being associated with the combination are read from the payout number area 92b and the winning pattern area 92c, respectively, and based on the read data, the payout number and the winning pattern are determined.

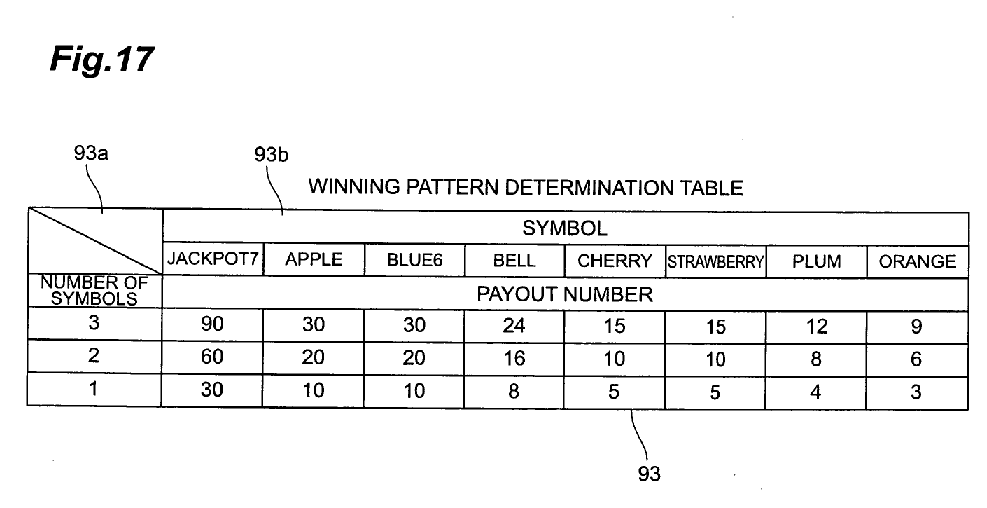

As shown in FIG. 17, the winning pattern determination table 93 has a symbol number area 93a and a symbol area 93b. In the symbol number area 93a, any one of the numbers of symbols, that is, “three”, “two”, and “one”, is set. In the symbol area 93b, the payout numbers of the respective symbols corresponding to the numbers of symbols “three”, “two”, and “one” are set. Unlike the winning pattern determination table 92, the winning pattern determination table 93 is designed so as to be capable of acquiring the payout number for each symbol using a part corresponding the symbol number code among the parts corresponding to the symbol codes of the symbols scheduled to come to a stop, which are displayed in a stopped state on each of the three variable display portions arranged along the specific line in the symbol area 93b. In addition, in comparison with the winning pattern determination table 92, for example, in the case of the winning pattern “APPLE”, in which the three aligned symbols “APPLE” have aligned, the payout number is “ten” in the winning pattern determination table 92, however, in contrast to this, the payout number is “30” in the winning pattern determination table 93 and thus the set payout number is greater.

As described above, in the slot machine 1, while the payout number is determined by the line-pay for the activated line, when the specific line is set, the payout number is determined by the any-pay for the specific line, and thus, the specific line is handled as a special line more profitable than the other activated lines. Moreover, the specific line is set based on the result of the random number lottery and can be changed each time. Consequently, unlike the case where only the line-pay is executed for each line, despite the plurality of the activated lines, it is possible to execute an interesting slot game with a diversity in which the plurality of the activated lines and the specific line are reflected effectively.

In addition, with the slot machine 1, it can be expected that the effect can be exerted (the game is enlivened) only by making the payout aspects differ from each other using the symbols displayed on the nine variable display portions 3A to 3I without the need to execute a variety of effect operations etc. using the images by the liquid crystal display on the main display 3 and the sub display 4.

In the above-mentioned case, in particular, the specific line is set in a straight line like the activated lines L1 to L8 and therefore the set specific line is recognized as a mysterious line with a different payout condition although its appearance is the same as that of the other activated lines. Moreover, when the specific line is set, images such as the specific line notification images 100 and 101 are displayed and the effect to enliven the slot game is executed by notifying the player of the specific line. Due to this, it is possible to attract the player's interest to whether or not the specific line is set and to the set specific line, and to execute a more interesting slot game. In addition, the specific line is set only when the predetermined condition is met, such as when the random number lottery is won etc., and there may be the case where the specific line is not set, and therefore, it is possible to give a feeling of tension to the game compared to the case where the specific line is set unconditionally.

In addition, in the slot machine 1 in the present embodiment, each time BLUE 7 is won during the free game and it is determined that the specific condition is met, three variable display portions to be set as the specific variable display portions are determined. Due to this, the specific variable display portion increases sequentially in number and the number of specific lines increases. The more the number of specific lines increases, the more advantageous the game becomes for the player, and the more likely the payout number increases, and therefore, it is possible to more stimulate the interest in the slot game during the free game.

### MODIFICATION EXAMPLES

In the above-mentioned explanation, the specific line is set by the main CPU 32 in step 19 based on the result of the random number lottery using the specific line lottery table 91, however, the specific line may also be set based on the input operation of the player. For example, it may also be possible to cause the main display 3 to display a selection screen in which one of the activated lines L1 to L8 is selected in step 19, and on the other hand, to cause the player to select one of the activated lines L1 to L8 by the input operation to touch the touch panel 3a, and set the specific line based on the input operation. If done this way, the player can select a desired line from among the activated lines L1 to L8 and thus the specific line is set by the same three variable display portions as those of the selected activated line. In addition, in this case, it may also be possible to display the above-mentioned selection screen when the setting condition is met and to make it possible to select a specific line.

In the above-mentioned slot machine 1, the specific line is set by the three variable display portions aligned in a straight line like the activated lines L1 to L8, however, it may also be possible to set a specific line by the variable display portions aligned nonlinearly, such as in an L-shaped form, a T-shaped form, etc. In this case, the number of variable display portions is not limited to three.

In addition, in the case where the man CPU 32 determines the payout number in step 47, when the same symbols are displayed in a stopped state on all of the variable display portions arranged along the set specific line, since the number of variable display portions arranged along the specific line is “three”, the payout number may be increased by a factor of 3 accordingly. For example, when the symbols on the specific line are all “BELL”, the payout number will be “24”, corresponding to the number of symbols “three” of the symbol “BELL” in the winning pattern determination table 93, however, it may be increased by a factor of three, that is, “72”. If done this way, the payout number is increased and therefore it is possible to attract the player's interest to the symbols displayed in a stopped state on the specific line and to make the slot game more interesting.

In the above-mentioned embodiments, the setting to increase the number of specific lines is executed in the free game, however, it may be executed in the base game by executing the same processes as those in steps 63 to 66 in the base game etc.

In addition, the number of specific variable display portions is controlled to increase when the above-mentioned specific condition is met, however, the number of specific variable display portions may be controlled to decrease. The specific condition in this case may be the same as the above-mentioned specific condition (BLUE 7 is won) or may be different from that.

In addition, in the coin insertion/start check process, after the operation of the BET switch is detected, the specific line is set (after step 15 is executed, step 17 is executed), however, it may also be possible to set the specific line after the operation of the spin switch is detected (after step 22 is executed, step 17 is executed).

In the above-mentioned embodiments, the nine variable display portions are provided, however, the number of variable display portions is not limited to nine, and it may be three or five.

As described above in detail, according to the present invention, in a gaming machine, such as a slot machine, including a plurality of variable display portions that variably display a plurality of symbols and capable of executing games using a plurality of activated lines in a linear pattern, such as a vertical, horizontal, or diagonal linear pattern, it is possible to provide a diversity to the contents of a game and make the game more attractive.

Specifically, a gaming machine according to the present invention includes: an image display means having a plurality of variable display portions, each of which variably displays a plurality of symbols; a symbol determination means for determining the symbol to be displayed in a stopped state on each of the variable display portions of the image display means; a line setting means for setting a plurality of activated lines, each of which is constituted by some of the variable display portions aligned in a straight line among the plurality of the variable display portions; a specific variable display portion setting means for setting at least one of the variable display portions among the plurality of the variable display portions as a specific variable display portion relatively advantageous for a player than each of the variable display portions; and a variation control means for changing the number of the specific variable display portions when a specific condition relating to at least one of the variable display portions among the plurality of the variable display portions is met.

In this gaming machine, it is possible to set at least any one of a plurality of variable display portions not set as a specific variable display portion as the specific variable display portion and to change the number of specific variable display portions when a specific condition is met.

The above-mentioned gaming machine may have a shifting means for shifting the game aspect from a base game aspect into a specific game aspect, which is more advantageous for a player than the base game aspect, and the specific variable display portion setting means may set at least one of the variable display portions among the plurality of the variable display portions as the specific variable display portion when the game aspect is shifted into the specific game aspect from the base game aspect by the shifting means.

Due to the above, at least one of the variable display portions is set as the specific variable display portion when the game aspect is shifted into the specific game aspect from the base game aspect.

Then, in the above-mentioned gaming machine, the specific variable display portion setting means may set the variable display portions constituting any one of the activated lines as the specific variable display portions.

Due to the above, the plurality of the variable display portions constituting any one of the activated lines is set as the specific variable display portions.

Further, the above-mentioned gaming machine may have a specific award determination means for determining the amount of specific game award to be provided to a player based on the symbol to be displayed in a stopped state on at least any one of the specific variable display portions set by the specific variable display portion setting means.

Due to the above, the amount of specific game award is determined based on the symbol to be displayed in a stopped state on at least any one of the specific variable display portions.

What is claimed is:

1. A gaming machine comprising:
a display having a plurality of variable display portions, each of which variably displays a plurality of symbols; and
a processor which determines the symbol to be displayed in a stopped state on each of the variable display portions of the display, and which sets a plurality of activated lines, each of which is constituted by some of the variable display portions aligned in a straight line among the plurality of the variable display portions, and which sets at least one of the variable display portions among the plurality of the variable display portions as a specific variable display portion relatively advantageous for a player than each of the variable display portions, and which changes the number of the specific variable display portions when a specific condition relating to at least one of the variable display portions among the plurality of the variable display portions is met.

2. The gaming machine according to claim 1,
wherein the processor shifts a game aspect from a base game aspect into a specific game aspect, which is more advantageous for a player than the base game aspect,
wherein the processor sets at least one of the variable display portions among the plurality of the variable display portions as the specific variable display portion when the game aspect is shifted into the specific game aspect from the base game aspect.

3. The gaming machine according to claim 1,
wherein the processor sets the variable display portions constituting one of the activated lines as the specific variable display portions.

4. The gaming machine according to claim 2,
wherein the processor sets the variable display portions constituting one of the activated lines as the specific variable display portions.

5. The gaming machine according to claim 1,
wherein the processor determines the amount of specific game award to be provided to the player based on the symbol to be displayed in a stopped state on at least any one of the specific variable display portions set by the processor.

6. The gaming machine according to claim 2,
wherein the processor determines the amount of specific game award to be provided to the player based on the symbol to be displayed in a stopped state on at least any one of the specific variable display portions set by the processor.

7. The gaming machine according to claim 3,
wherein the processor determines the amount of specific game award to be provided to the player based on the symbol to be displayed in a stopped state on at least any one of the specific variable display portions set by the processor.

8. The gaming machine according to claim 4,
wherein the processor determines the amount of specific game award to be provided to the player based on the symbol to be displayed in a stopped state on at least any one of the specific variable display portions set by the processor.
